(19) United States
(12) Patent Application Publication
(10) Pub. No.: US 2015/0019995 A1
(43) Pub. Date: Jan. 15, 2015

(54) IMAGE DISPLAY APPARATUS AND METHOD OF OPERATING THE SAME

(71) Applicant: Samsung Electronics Co., Ltd., Suwon-si (KR)

(72) Inventors: Hak-sup SONG, Suwon-si (KR); Kun-sok KANG, Yongin-si (KR); Sung-hyun KIM, Yongin-si (KR); Tae-ho KIM, Suwon-si (KR); Joo-whan LEE, Seongnam-si (KR); Mi-jin CHOI, Seoul (KR)

(73) Assignee: Samsung Electronics Co., Ltd., Suwon-si (KR)

(21) Appl. No.: 14/323,338

(22) Filed: Jul. 3, 2014

(30) Foreign Application Priority Data
Jul. 15, 2013 (KR) 10-2013-0083151

(51) Int. Cl. G06F 3/0482; G06K 9/00

(52) U.S. Cl. CPC G06F 3/0482; G06K 9/00288
USPC 715/750

(57) ABSTRACT

Provided are an image display apparatus and a method of operating the same. The method includes recognizing a plurality of users, displaying a selection menu configured to allow selection of a personal screen corresponding to each of the recognized plurality of users, receiving an input selecting at least one personal screen from the selection menu, and displaying the selected at least one personal screen, wherein the at least one personal screen includes personal content based on user information.

### RELATED APPLICATIONS

This application claims priority from Korean Patent Application No. 10-2013-0083151, filed on Jul. 15, 2013, in the Korean Intellectual Property Office, the disclosure of which is incorporated herein by reference in its entirety.

### BACKGROUND

1. Field

Apparatuses and methods consistent with exemplary embodiments relate to an image display apparatus and a method of operating the same, and more particularly, to an image display apparatus and a method of operating the same, in which a personal screen corresponding to each of a plurality of users is provided.

2. Description of the Related Art

Image display apparatuses have at least the function of displaying an image or other content that users may view. For example, a user may view broadcast images through an image display apparatus. Further, the image display apparatus may display broadcast images that are selected by the user, from a broadcast signal broadcast from a broadcasting station, on a display device. Currently, most countries around the world have switched from analog broadcasting to digital broadcasting.

Digital broadcasting refers to broadcasting which provides digital images and audio signals. When compared to analog broadcasting, digital broadcasting is considered resilient against external noise, thus having less data loss, and is favorable to error correction. Digital broadcasting also enables high resolution and the use of high-definition screens. Digital broadcasting may also provide an interactive service unlike analog broadcasting.

Recently, smart televisions (TVs) providing various functions and content, in addition to a digital broadcasting function, have been provided. Smart TVs may analyze and provide content to a user without the user's manipulation, instead of manual operation according to the user's selection.

### SUMMARY

According to an aspect of an exemplary embodiment, there is provided a method of operating an image display apparatus, the method including recognizing a plurality of users, displaying a selection menu configured to allow selection of a personal screen corresponding to each of the recognized plurality of users, receiving an input selecting at least one personal screen from the selection menu, and displaying the selected at least one personal screen, wherein the at least one personal screen includes personal content based on user information.

The method may further include receiving an entry command for entering a personal screen mode, and recognizing the plurality of users in response to receiving the entry command for entering the personal screen mode.

The method may further include receiving user authentication information, and displaying the selected personal screen in response to the received user authentication information matching user identification information corresponding to the selected personal screen.

The user authentication information may include at least one of user face information, predetermined pattern information, user voiceprint information, and a password.

The selection menu may include an object indicating the at least one personal screen.

The displaying the selected at least one personal screen may include displaying some predetermined content from among content included in the selected personal screen.

The displaying the selected at least one personal screen may include displaying a plurality of personal screens on different regions of a display in response to the plurality of personal screens being selected.

The personal content may include recommended content based on a usage time of the image display apparatus and shared content from another user.

The user information may include at least one of a gender, an age, a content use history, a search history, and a field of interest of a user.

The method may further include terminating the displaying of the personal screen in response to losing recognition of a user corresponding to the displayed at least one personal screen.

The method may further include terminating the displaying of the at least one personal screen in response to recognizing a new user who is different from the recognized plurality of users.

According to an aspect of another exemplary embodiment, there is provided an image display apparatus including a user recognition unit configured to recognize a plurality of users, a display configured to display a selection menu configured for selecting a personal screen corresponding to each of the recognized plurality of users, a user input receiver configured to receive an input selecting at least one personal screen from the selection menu, and a controller configured to control the displaying of the selected personal screen, wherein the at least one personal screen includes personal content based on user information.

The controller may be further configured to recognize the plurality of users in response to receiving an entry command for entering a personal screen mode.

The user input receiver may be further configured to receive user authentication information, and wherein the controller may be further configured to control the displaying of the selected personal screen in response to the received user authentication information matching user identification information corresponding to the selected personal screen.

The user authentication information may include at least one of user face information, predetermined pattern information, user voiceprint information, and a password.

The controller may be further configured to control the displaying of some predetermined content from among content included in the selected at least one personal screen.

The controller may be further configured to control the displaying of a plurality of personal screens on different regions of the display in response to the plurality of personal screens being selected.

The personal content may include recommended content based on a usage time of the image display apparatus and shared content from another user.

The user information may include at least one of a gender, an age, a content use history, a search history, and a field of interest of the user.

According to an aspect of another exemplary embodiment, there is provided a non-transitory computer-readable recording medium having recorded thereon a program for executing a method of operating an image display apparatus on a computer, the method including recognizing a plurality of users, displaying a selection menu configured to allow selection of a personal screen corresponding to each of the recognized plurality of users, receiving an input selecting at least one personal screen from the selection menu, and displaying the selected at least one personal screen, wherein the at least one personal screen includes personal content based on user information.

### BRIEF DESCRIPTION OF THE DRAWINGS

These and/or other aspects will become apparent and more readily appreciated from the following description of the exemplary embodiments, taken in conjunction with the accompanying drawings of which:

FIG. 1 is a block diagram showing an image display apparatus according to an exemplary embodiment;

FIG. 2 is a block diagram showing an image display apparatus according to another exemplary embodiment;

FIG. 3 is a block diagram showing a remote controller according to an exemplary embodiment;

FIG. 4 is a flowchart of a method of operating an image display apparatus according to an exemplary embodiment;

FIG. 5 is a diagram showing a user recognition operation according to an exemplary embodiment;

FIG. 6 is a diagram showing a selection menu displayed on a display according to an exemplary embodiment;

FIG. 7 is a diagram showing a selection menu displayed on a display according to another exemplary embodiment;

FIG. 8 is a diagram showing a selection menu displayed on a display according to another exemplary embodiment;

FIG. 9 is a diagram showing a personal screen displayed on a display according to an exemplary embodiment;

FIG. 10 is a diagram showing a method of displaying a personal screen according to an exemplary embodiment;

FIG. 11 is a diagram showing a method of displaying a personal screen according to another exemplary embodiment;

FIG. 12 is a flowchart of a method of operating an image display apparatus according to another exemplary embodiment;

FIG. 13 is a diagram showing an authentication method according to an exemplary embodiment;

FIG. 14 is a diagram showing an authentication method according to another exemplary embodiment;

FIG. 15 is a diagram showing an authentication method according to another exemplary embodiment;

FIG. 16 is a diagram showing an operation of terminating personal screen display according to an exemplary embodiment; and

FIG. 17 is a diagram showing an operation of terminating personal screen display according to another exemplary embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Suffixes “module” and “unit” or “portion” used for components in the following description are merely provided only for facilitation of preparing this specification, and thus they are not granted a specific meaning or function. Hence, it should be noticed that “module” and “unit” or “portion” can be used together.

The term “ . . . unit” used in the embodiments indicates a component including software or hardware, such as a Field Programmable Gate Array (FPGA) or an Application-Specific Integrated Circuit (ASIC), and the “ . . . unit” performs certain roles. However, the “ . . . unit” is not limited to software or hardware. The “ . . . unit” may be configured to be included in an addressable storage medium or to reproduce one or more processors. Therefore, for example, the “ . . . unit” includes components, such as software components, object-oriented software components, class components, and task components, processes, functions, attributes, procedures, subroutines, segments of program code, drivers, firmware, microcode, circuits, data, a database, data structures, tables, arrays, and variables. A function provided inside components and “ . . . units” may be combined into a smaller number of components and “ . . . units”, or further divided into additional components and “ . . . units”.

The term “module” as used herein means, but is not limited to, a software or hardware component, such as an FPGA or ASIC, which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Although the terms used herein are generic terms which are currently widely used and are selected by taking into consideration functions thereof, the meanings of the terms may vary according to the intentions of persons skilled in the art, legal precedents, or the emergence of new technologies. Furthermore, some specific terms may be randomly selected by the applicant, in which case the meanings of the terms may be specifically defined in the description of the exemplary embodiment. Thus, the terms should be defined not by simple appellations thereof but based on the meanings thereof and the context of the description of the exemplary embodiment. As used herein, expressions such as “at least one of,” when preceding a list of elements, modify the entire list of elements and do not modify the individual elements of the list.

It will be understood that when the terms “includes,” “comprises,” “including,” and/or “comprising,” when used in this specification, specify the presence of stated elements and/or components, but do not preclude the presence or addition of one or more elements and/or components thereof. As used herein, the term “module” refers to a unit that can perform at least one function or operation and may be implemented utilizing any form of hardware, software, or a combination thereof.

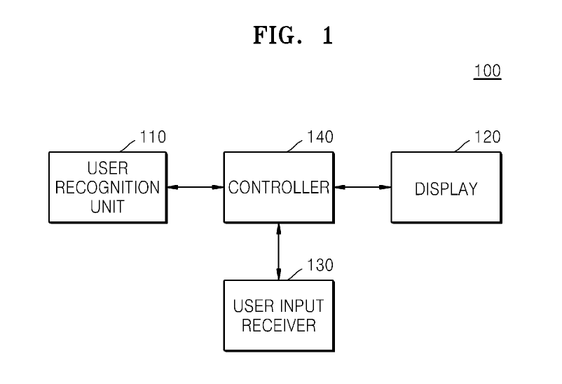

FIG. 1 is a block diagram of an image display apparatus 100 according to an exemplary embodiment.

Referring to FIG. 1, the image display apparatus 100 according to the present exemplary embodiment may include a controller 140, a display 120, a user recognizer 110, and a user input receiver 130.

The user recognition unit 110 may include a camera. The user recognition unit 110 captures an image of a user and recognizes the user based on the captured image. The user recognition unit 110 may be implemented with one camera, but may also be implemented with a plurality of cameras.

The camera may be included in the image display apparatus 100 and may be disposed on the display 120 or separately provided. The image captured by the camera may be input to the controller 140.

The controller 140 processes an image signal and inputs the processed image signal to the display 120, such that an image corresponding to the image signal is displayed on the display 120. The controller 140 also controls the image display apparatus 100 according to a user command or an internal program that is input through the user input receiver 130.

For example, according to an exemplary embodiment, the controller 140 may control a personal screen, which is selected by a user input, to be displayed on the display 120.

The controller 140 recognizes a user's location based on the image captured by the user recognition unit 110. For example, the controller 140 may recognize a distance (a z-axis coordinate) between the user and the image display apparatus 100. The controller 140 may also recognize an x-axis coordinate and a y-axis coordinate corresponding to the user's location in the display 120.

According to an exemplary embodiment, the controller 140 may control the user recognition unit 110 to recognize the user, if it receives a command for entering a personal screen mode.

The display 120 converts an image signal, a data signal, an on-screen display (OSD) signal, and a control signal processed by the controller 140 to generate a drive signal.

The display 120 may be implemented as a plasma display panel (PDP), a liquid crystal display (LCD), an organic light emitting diode (OLED), or a flexible display, and may also be implemented as a three-dimensional (3D) display.

The display 120 may be implemented with a touch screen to be used as an input device as well as an output device.

In relation to an exemplary embodiment, the display 120 may display a selection menu for selecting a personal screen corresponding to each of a recognized plurality of users.

The user input receiver 130 forwards the user-input signal to the controller 140 or a signal that is output from the controller 140 to the user.

According to an exemplary embodiment, the user input receiver 130 receives an input for selecting at least one personal screen from a selection screen displayed on the display 120.

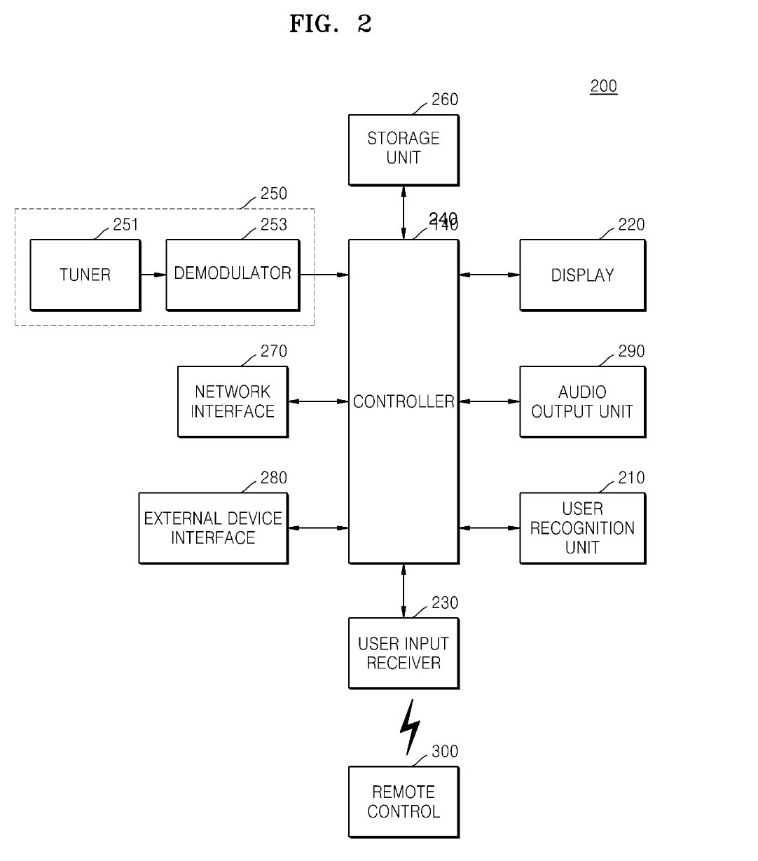

FIG. 2 is a block diagram showing an image display apparatus 200 according to another embodiment.

Referring to FIG. 2, the image display apparatus 200 according to another embodiment may include a controller 240, a display 220, a user recognition unit 210, a user input receiver 230, a broadcasting reception unit 250, an external device interface 280, a storage unit 260, a sensor unit, and an audio output unit 290.

The broadcasting reception unit 250 may include a tuner 251, a demodulator 253, and a network interface 270. The broadcasting reception unit 250 may also be designed to include the tuner 251 and the demodulator 253 without including the network interface 270. On the other hand, the broadcasting reception unit 250 may be designed to include the network interface 270 without including the tuner 251 and the demodulator 253.

The tuner 251 tunes a radio frequency (RF) broadcast signal corresponding to a channel selected by a user or all the previously stored channels from RF broadcast signals received via an antenna. The tuner 251 also converts the tuned RF broadcast signal into an intermediate frequency (IF) signal or a baseband image or audio signal.

For example, if the tuned RF broadcast signal is a digital broadcast signal, the tuner 251 may convert the tuned RF broadcast signal into a digital IF (DIF) signal, and if the tuned RF broadcast signal is an analog signal, the tuner 251 may convert the tuned RF broadcast signal into an analog baseband image or audio signal (CVBS/SIF). That is, the tuner 251 may process the digital broadcast signal or the analog broadcast signal. The analog baseband image or audio signal (CVBS/SIF) output from the tuner 251 is directly input to the controller 240.

The tuner 251 receives an RF broadcast signal with a single carrier according to an Advanced Television System Committee (ATSC) standard or an RF broadcast signal with a plurality of carriers according to a Digital Video Broadcasting (DVB) standard.

In an exemplary embodiment, the tuner 251 may sequentially tune RF broadcast signals of all broadcast channels stored using a channel memory function from the RF broadcast signal received via the antenna, and convert the tuned RF broadcast signals into IF signals or baseband image or audio signals.

The tuner 251 may include a plurality of tuners to receive broadcast signals of a plurality of channels. The tuner 251 may also include a single tuner which simultaneously receives broadcast signals of a plurality of channels.

The demodulator 253 receives the DIF signal obtained by conversion in the tuner 251 and performs demodulation on the received DIF signal.

The demodulator 253 outputs a stream signal (TS) after performing demodulation and channel decoding. The stream signal may be a result of multiplexing an image signal, an audio signal, or a data signal.

The stream signal output from the demodulator 253 may be input to the controller 240. The controller 240 performs demultiplexing and image/audio signal processing, and then outputs an image on the display 220 and audio to the audio output unit 290.

The external device interface 280 transmits or receives data to or from a connected external device. To this end, the external device interface 280 may include an audio/video (A/V) input and output unit or a wireless communication unit.

The external device interface 280 may be connected to an external device, such as a digital versatile disk (DVD) player, a Blu-ray disc (BD) player, a game console, a camera, a camcorder, a computer (notebook computer), or a set-top box in a wired or wireless manner, and may perform an input/output operation in association with the external device.

The A/V input and output unit may receive image and audio signals of the external device. The wireless communication unit may perform short-range wireless communication with other electronic devices.

The network interface 270 provides an interface for connecting the image display apparatus 200 with a wired/wireless network including the Internet network. For example, the network interface 270 may receive content or data provided by the Internet, a content provider, or a network operator through a network.

The storage unit 260 stores programs for signal processing and control of the controller 240 or signal-processed image, audio, or data signals.

The storage unit 260 performs a function for temporarily storing image, audio, or data signals that are input to the external device interface 280. The storage unit 240 may also stores information about a predetermined broadcast channel by using a channel memory function such as a channel map.

Although FIG. 2 shows an exemplary embodiment in which the storage unit 260 is provided separately from the controller 240, the scope is not limited thereto. The storage unit 260 may be included in the controller 240.

The user input receiver 230 forwards a user input signal to the controller 240 or forwards a signal to the user from the controller 240.

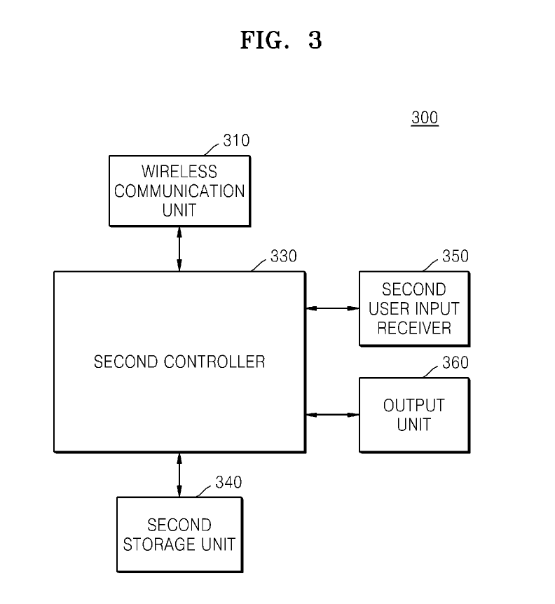

For example, the user input receiver 230 may transmit/receive a user input signal, such as power on/off, channel selection, or screen setting, from a remote control 300 to be described with reference to FIG. 3, forward a user input signal that is input through a local key, such as a power key, a channel key, a volume key, or a setting key, to the controller 240, forward a user input signal that is input from a sensor unit for sensing a user's gesture to the controller 240, or transmit a signal from the controller 240 to the sensor unit.

According to an exemplary embodiment, the user input receiver 230 may receive an input for selecting at least one personal screen from a selection menu displayed on the display 220.

The controller 240 demultiplexes an input stream and processes multiplexed signals to generate and output signals for image or audio output, through the tuner 251, the demodulator 253, or the external device interface 280.

The image signal that is image-processed by the controller 240 is input to the display 220 and is displayed as an image corresponding to the image signal. The image signal that is image-processed by the controller 240 is input to the external output device through the external device interface 280.

The audio signal processed by the controller 240 is output to the audio output unit 290. The audio signal processed by the controller 240 is input to the external output device through the external device interface 280.

Although not shown in FIG. 2, a demultiplexing unit and an image processing unit may be included in the controller 240.

The controller 240 controls overall operations of the image display apparatus 200. For example, the controller 240 may control the tuner 251 to tune RF broadcasting corresponding to a user-selected channel or a previously stored channel.

The controller 240 controls the image display apparatus 200 according to a user command that is input through the user input receiver 230 or an internal program.

For example, according to an exemplary embodiment, the controller 240 controls display of a personal screen selected by a user input.

The controller 240 controls the display 220 to display an image. The image displayed on the display 220 may be a still or moving image or a 3D image.

The controller 240 recognizes a user's location based on the image captured by the user recognition unit 210. For example, the controller 240 may recognize a distance (a z-axis coordinate) between the user and the image display apparatus 200. The controller 240 may also recognize an x-axis coordinate and a y-axis coordinate corresponding to the user's location in the display 220.

According to an exemplary embodiment, the controller 240 may control the user recognition unit 210 to recognize the user, if it receives a command for entering the personal screen mode.

The display 220 converts an image signal, a data signal, an OSD signal, or a control signal processed by the controller 240 or an image signal, a data signal, or a control signal received by the external device interface 280 to generate a drive signal.

The display 220 may include a PDP, an LCD, an OLED, or a flexible display, or may also include a 3D display.

The display 220 may include a touch screen to serve as an input device as well as an output device.

The audio output unit 290 receives the signal that is audio-processed by the controller 240 and outputs audio.

The user recognition unit 210 may include a camera. The user recognition unit 210 captures the user by using the camera, and recognizes the user based on the captured image. The user recognition unit 210 may be implemented with one camera, but may also be implemented with a plurality of cameras. The camera may be included in the image display apparatus 200, and may be disposed on the display 220 or separately provided. The image captured by the camera may be input to the controller 240.

The controller 240 senses a user's gesture based on the image captured by the camera or the signal sensed by the sensor unit, or a combination thereof.

The remote control 300 transmits a user input to the user input receiver 230. To this end, the remote control 300 may use Bluetooth, RF communication, infrared (IR) communication, ultra wideband (UWB), or Zigbee. The remote control 300 receives an image, audio, or data signal that is output from the user input receiver 230 and displays the signal thereon or outputs the signal as audio.

The image display apparatuses 100 and 200 may be fixed or mobile digital broadcasting receivers capable of receiving digital broadcasting.

An image display apparatus described herein may include a TV set, a monitor, a cellular phone, a smart phone, a notebook computer, a digital broadcasting terminal, a personal digital assistant (PDA), or a portable multimedia player (PMP).

The block diagrams of FIGS. 1 and 2 showing the image display apparatuses 100 and 200 are block diagrams for an exemplary embodiment. Each component of the block diagrams may be integrated, added, or omitted according to specifications of the actually implemented image display apparatuses 100 and 200. That is, two or more components may be integrated into one component or one component may be divided into two or more components. A function performed in each block is intended to describe an exemplary embodiment, and detailed operations or devices do not limit the scope.

Unlike in FIG. 2, the image display apparatus 200 may receive image content and play back the image content through the network interface 270 or the external device interface 280, without including the tuner 251 and the demodulator 253 shown in FIG. 2.

The image display apparatuses 100 and 200 are examples of an image signal processing apparatus for performing signal processing on an image stored in the apparatus or an input image. Another example of the image signal processing apparatus may include the set-top box, the DVD player, the Blu-ray player, the game console, or the computer from which the display 220 and the audio output unit 290 shown in FIG. 2 are excluded.

FIG. 3 is a block diagram showing the remote control 300 shown in FIG. 2.

Referring to FIG. 3, the remote control 300 may include a wireless communication unit 310, a second user input receiver 350, an output unit 360, a second storage unit 340, and a second controller 330.

The wireless communication unit 310 transmits and receives signals with any one of image display apparatuses according to the one or more of the exemplary embodiments described above. Among the image display apparatuses according to one or more of the exemplary embodiments, an image display apparatus will be described as an example.

In the current exemplary embodiment, the wireless communication unit 310 may include an IR module capable of transmitting and receiving signals with the image display apparatuses 100 and 200 according to IR communication standards.

Thus, the remote control 300 may transmit a command associated with power on/off, channel change, or volume change to the image display apparatuses 100 and 200 through the IR module.

The second user input receiver 350 may include a keypad, a button, a touch pad, or a touch screen. The user may manipulate the second user input receiver 350 to input a command associated with the image display apparatuses 100 and 200 to the remote control 300. If the user input receiver 350 includes a hard key button, the user may input a command associated with the image display apparatuses 100 and 200 to the remote control 300 through a push operation of the hard key button. If the second user input receiver 350 includes a touch screen, the user may touch a soft key of the touch screen to input a command associated with the image display apparatuses 100 and 200 to the remote control 300. The second user input receiver 350 may include various kinds of input means that the user may manipulate, such as a scroll wheel or a jog dial, and the current exemplary embodiment does not limit the scope.

The output unit 360 outputs an image or audio signal corresponding to manipulation of the second user input receiver 350 or corresponding to a signal transmitted from the image display apparatuses 100 and 200. The user recognizes manipulation of the second user input receiver 350 or control of the image display apparatuses 100 and 200 through the output unit 360.

For example, the output unit 360 may include an LED module that lights up, a vibration module that generates vibration, an audio output module that outputs audio, or a display module that outputs an image when the second user input receiver 350 is manipulated or a signal is transmitted to or received from the image display apparatuses 100 and 200 through the wireless communication unit 310.

The second storage unit 340 stores various kinds of programs and application data for control or operation of the remote control 300.

The second controller 330 controls overall operations related to control of the remote control 300. The second controller 330 transmits a signal corresponding to predetermined key manipulation of the second user input receiver 350 to the image display apparatuses 100 and 200 through the wireless communication unit 310.

The second user input receiver 350 receives a signal transmitted by the remote control 300 according to IR communication standards through an IR module.

The signal input to the image display apparatuses 100 and 200 through the second user input receiver 130 is transmitted to the controller 140 of the image display apparatuses 100 and 200. The controller 140 identifies information regarding operations and key manipulation of the remote control 300 from the signal transmitted from the remote control 300 and controls the image display apparatuses 100 and 200 based on the information.

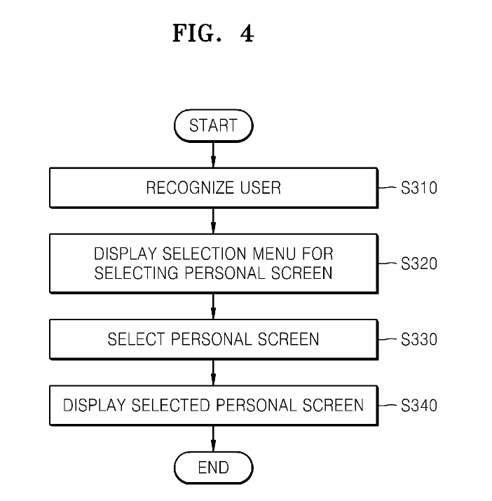

FIG. 4 is a flowchart of a method of operating an image display apparatus according to an exemplary embodiment.

Referring to FIG. 4, the image display apparatuses 100 and 200 may recognize a plurality of users in operation S310.

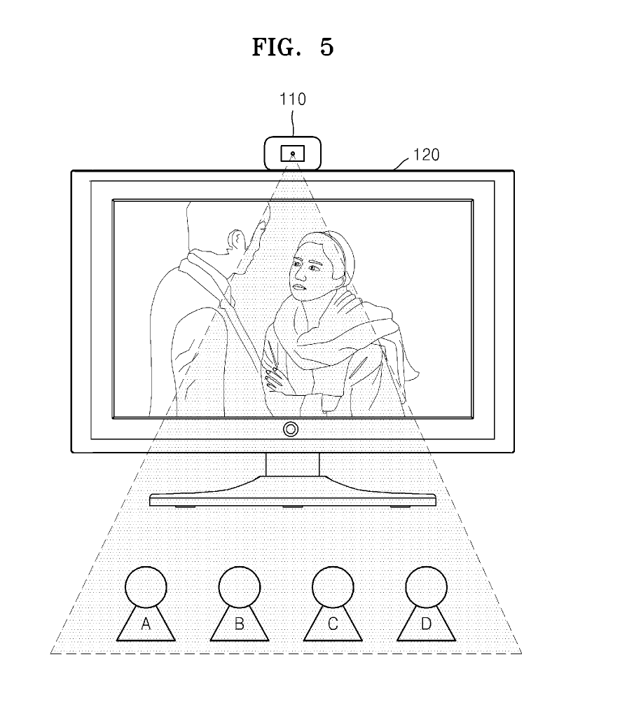

For example, as shown in FIG. 5, the user recognition unit 110 or 210 may include a camera. The camera may trace a user's location in real time by using eye-tracking, capture an image of a face of the tracked user, and recognize the face of the user based on the captured image. Alternatively recognition may also be done by a user defined gesture or a user defined audio phrase.

When the user registers a personal screen, the user may also register a user's face corresponding to the personal screen, such that the controller 140 may compare the user's face recognized by the user recognition unit 110 with the registered user's face and detect the personal screen corresponding to the user recognized by the user recognition unit 110.

For example, as shown in FIG. 5, the user recognition unit 110 may recognize a first user A, a second user B, a third user C, and a fourth user D, and the controller 140 may detect a first personal screen corresponding to the first user A, a second personal screen corresponding to the second user B, a third personal screen corresponding to the third user C, and a fourth personal screen corresponding to the fourth user D.

The image display apparatuses 100 and 200 receive an entry command for entering the personal screen mode, and the controller 140 controls the user recognition unit 110 to recognize the plurality of users if it receives the entry command. The entry command for entering the personal screen mode may include at least one of an input of a particular key, an input of a particular motion, and an input of a particular command.

For example, if the user presses a particular key/a particular button included in the remote control 300, performs a particular motion, or speaks a particular word, the controller 140 may control the user recognition unit 110 to perform user recognition.

As such, the image display apparatuses 100 and 200 perform user recognition upon receiving the entry command for entering the personal screen mode, thus saving power consumed by the user recognition unit 110.

According to an exemplary embodiment, if there is no registered user's face that matches the recognized user's face, the image display apparatuses 100 and 200 may register a personal screen corresponding to the recognized user's face.

The image display apparatuses 100 and 200 may display a selection menu for selecting a personal screen corresponding to each of a recognized plurality of users in operation S320.

For example, as stated above, if the controller 140 detects the first through fourth personal screens corresponding to the recognized first through fourth users A, B, C, and D, respectively, then a selection menu for selecting at least one of the first through fourth personal screens may be displayed on the display 120.

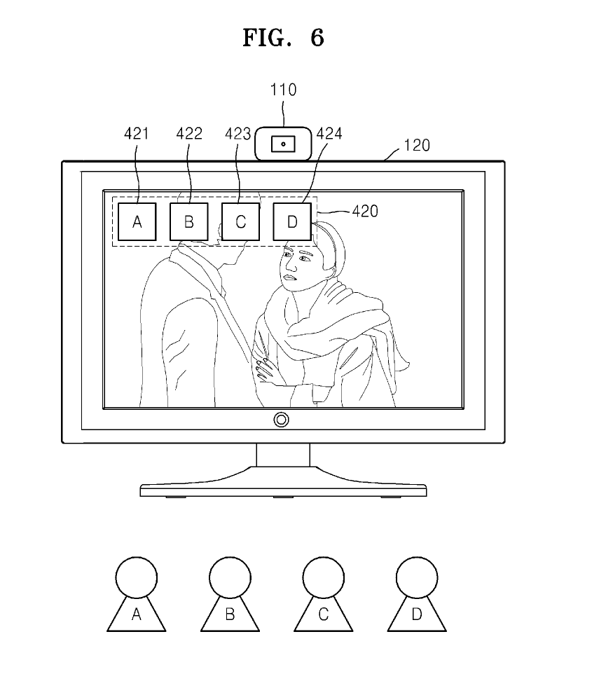

According to an exemplary embodiment, the selection menu may include an object corresponding to each personal screen. For example, as shown in FIG. 6, a selection menu 420 may include a first icon 421 corresponding to the first personal screen, a second icon 422 corresponding to the second personal screen, a third icon 423 corresponding to the third personal screen, and a fourth icon 424 corresponding to the fourth personal screen.

The first through fourth icons 421, 422, 423, and 424 include respective identification information. For example, if a first user A registers an identification (ID) of a first personal screen as ‘A’ when registering the first personal screen, the ID ‘A’ is displayed together with the first icon 421, such that the user may easily recognize that the first icon 421 displayed with ‘A’ indicates the first personal screen.

The first through fourth icons 421, 422, 423, and 424 may also be displayed as user's facial images or avatars corresponding to them, thus making it easy for the user to identify a personal screen corresponding to each icon.

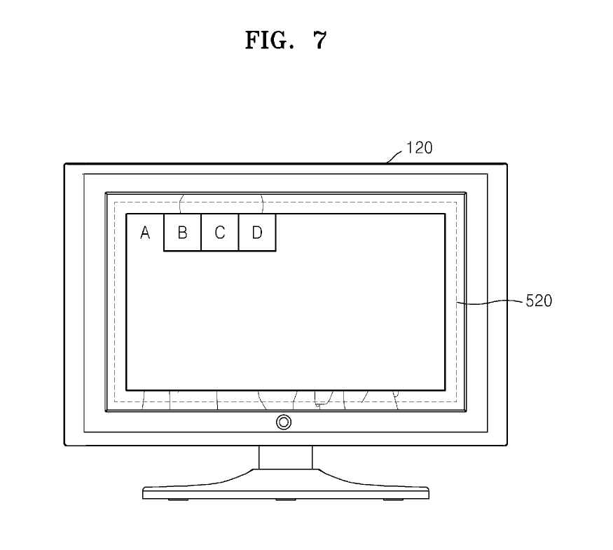

As shown in FIG. 7, a selection menu 520 may show personal screens corresponding to the recognized plurality of users in the form of bookmarks.

In this case, the personal screen shown in the selection menu 520 may display partial content included in the personal screen.

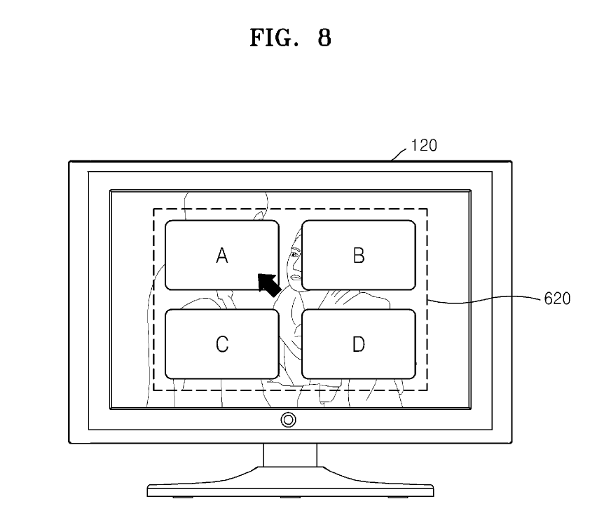

As shown in FIG. 8, a selection menu 620 may include thumbnails A, B, C, and D for the personal screens corresponding to the recognized plurality of users, respectively. The thumbnails A, B, C, and D may be size-reduced images of the first through fourth personal screens.

As shown in FIGS. 6 through 8, once the selection menus 420, 520, and 620 are displayed, the image display apparatuses 100 and 200 may receive an input for selecting at least one personal screen from a selection menu in operation S330.

In this case, one personal screen may be selected or two or a plurality of personal screens may be selected.

The image display apparatuses 100 and 200 display the selected personal screen on the display 120 in operation S340.

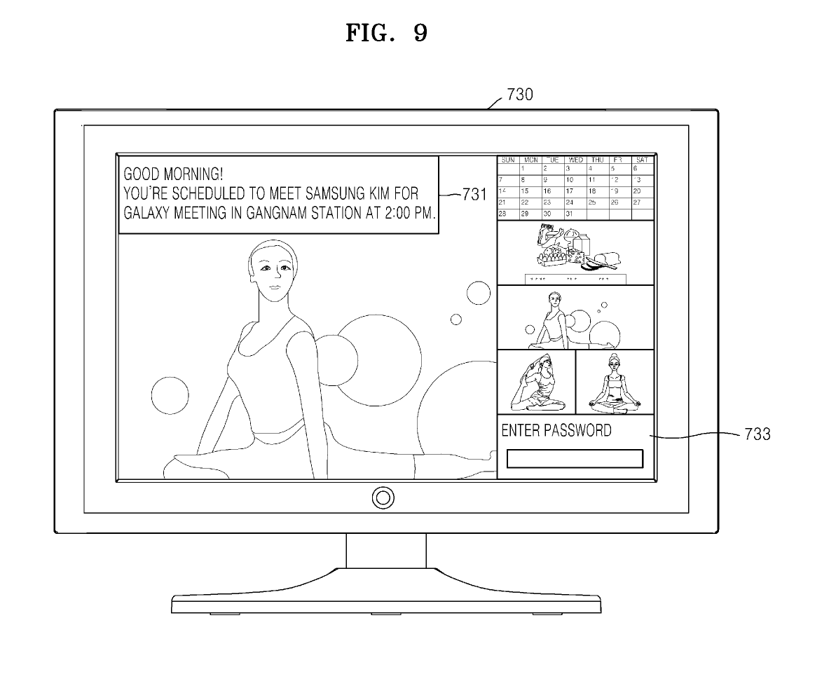

For example, as shown in FIG. 9, the controller 140 may display a selected personal screen 730 on the display 120 and the personal screen 730 may include a plurality of content. The content may include at least one of real-time broadcasting, a game, a moving image, audio, a text, and an application.

The personal screen 730 may also include personal content. For example, the personal screen 730 may include content the user often use, content recommended based on user information, recommended content based on a time when the image display apparatus is used, and content shared by other users.

The user information may include at least one of a user's gender, age, content use history, search history, channel view history, and field of interest. The personal content may be content recommended based on the user information.

For example, if the user is a female in her 20s, content that females in their 20s most frequently use may be recommended by a recommendation server, and the image display apparatuses 100 and 200 may display the recommended content on the personal screen 730.

Based on the user's channel view history and the time in which the image display apparatus is used, a broadcast channel viewed most frequently by the user during the use of the image display apparatus may be displayed on the personal screen 730.

The user information may be information received from an external device. For example, the information such as the content use history, the search history, the channel view history, and the field of interest may be received from an external device (for example, a mobile terminal, a tablet, and so forth) cooperating with the image display apparatuses 100 and 200.

The external device may transmit user information to a recommendation server which then may transmit content recommended based on the received user information to the image display apparatuses 100 and 200. The image display apparatuses 100 and 200 may display the recommended content received from the recommendation server to be included in the personal screen 730.

As shown in FIG. 9, the personal screen 730 may include an alarm message 731 including a user's schedule information.

The image display apparatuses 100 and 200 may display some of content included in the personal screen 730 without displaying some others.

The image display apparatuses 100 and 200 may receive a password for display-limited content 733 and display the content 733 according to whether the received password is correct.

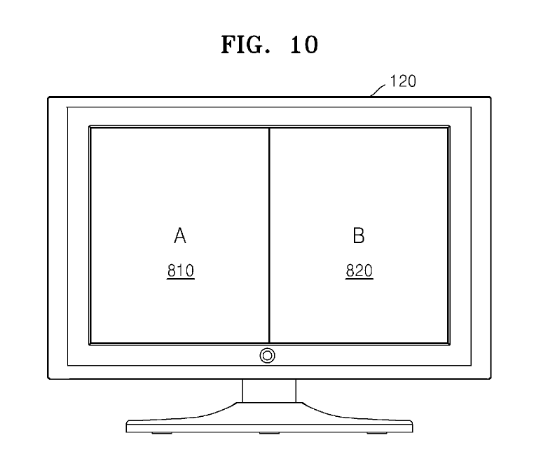

If a plurality of personal screens are selected from selection menus 420, 520, and 620, as shown in FIG. 10, the image display apparatuses 100 and 200 may display a plurality of personal screens A and B on different regions 810 and 820 of the display 120.

For example, if the first personal screen A and the second personal screen B are selected, the image display apparatuses 100 and 200 may display the first personal screen A on the first region 810 of the display 120 and the second personal screen B on the second region 820 of the display 120.

A ratio of the first region 810 to the second region 820 may be set by a user input.

According to another exemplary embodiment, the first personal screen A and the second personal screen B may be controlled separately. For example, the first personal screen A may be controlled by a first external device cooperating with an image display apparatus, and the second personal screen B may be controlled by a second external device cooperating with the image display apparatus.

An audio signal with respect to the first personal screen A may be output using the first external device, and an audio signal with respect to the second personal screen B may be output using the second external device.

The image display apparatuses 100 and 200 may control a selected personal screen to be displayed on an external device.

For example, if the first external device (Device 1) and the second external device (Device 2) cooperate with the image display apparatuses 100 and 200, the image display apparatuses 100 and 200 may receive an input for selecting at least one of the first external device (Device 1) and the second external device (Device 2).

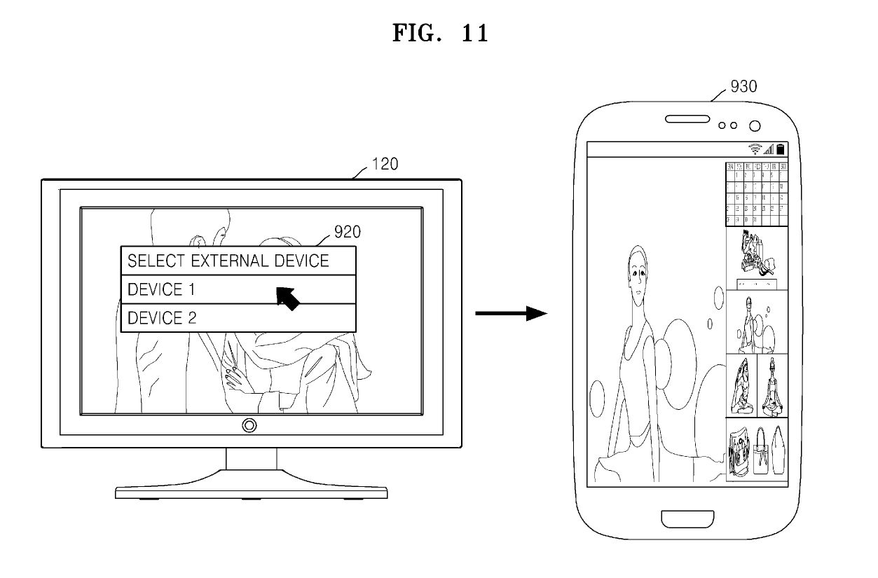

As shown in FIG. 11, upon receiving an input for selecting the first external device (Device 1), the image display apparatuses 100 and 200 may transmit data regarding a selected personal screen to a first external device 930 (Device 1). Thus, the first external device 930 (Device 1) may receive data regarding the selected personal screen from the image display apparatuses 100 and 200 and display the selected personal screen on a display.

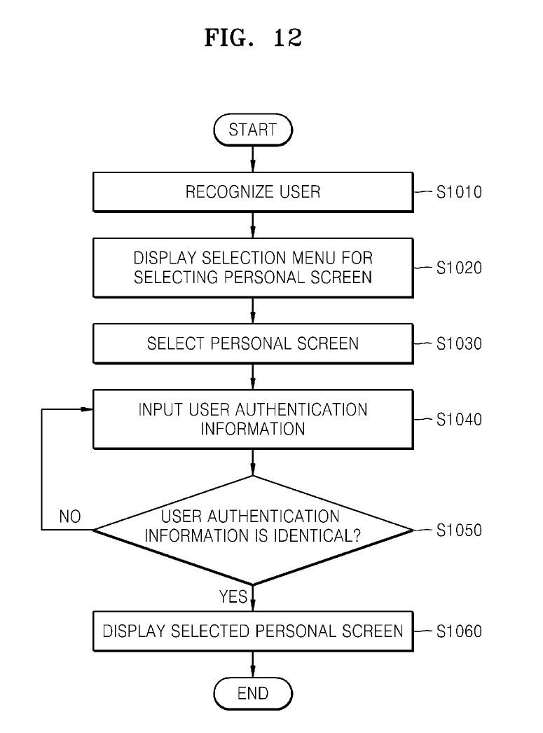

FIG. 12 is a flowchart of a method of operating an image display apparatus according to an exemplary embodiment.

Operation S1010 of FIG. 12 recognizes one or more users, in a similarly to operation S410 of FIG. 4. Operation S1020 of FIG. 12 displays a selection menu for selecting personal screen similar to operation S420 of FIG. 4. Operation S1030 of FIG. 12 receives a selection of a personal screen similar to operation S430 of FIG. 4.

Thus, a detailed description of operations S1010, S1020, and S1030 of FIG. 12 respectively corresponding to operations S410, S420, and S430 of FIG. 4, will not be repeated here.

The image display apparatuses 100 and 200 receives user authorization information if a personal screen is selected, in operation S1040.

The user authentication information may include at least one of user face information, pattern information, a password, and user voiceprint information.

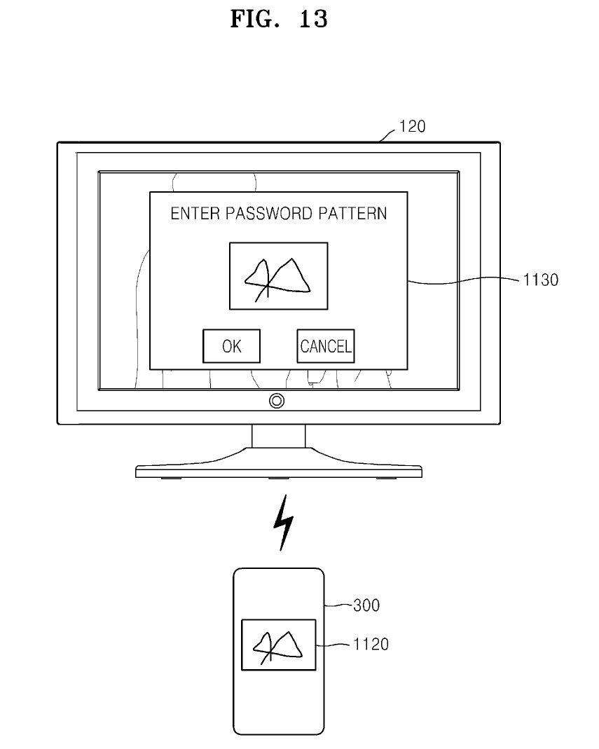

For example, as shown in FIG. 13, if receiving an input for selecting the first personal screen, the image display apparatuses 100 and 200 may display a message 1130 requesting input of a password pattern on the display 120.

Hence, the user may input a predetermined pattern by using a touchpad 1120 of the remote control 300. The image display apparatuses 100 and 200 may display the input predetermined pattern on the display 120 by using the remote control 300.

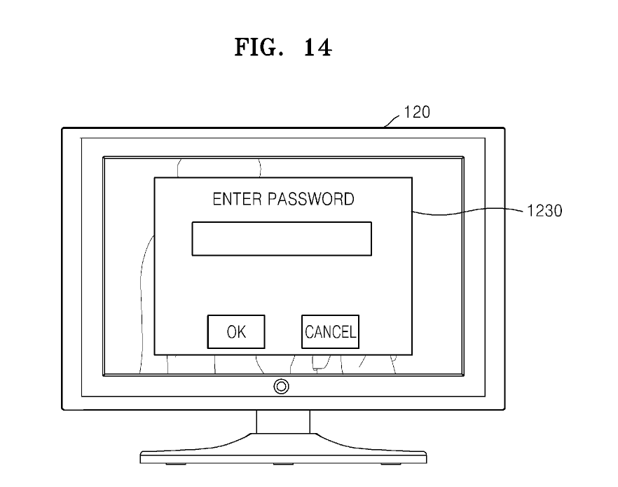

As shown in FIG. 14, if receiving the input for selecting the personal screen, the image display apparatuses 100 and 200 may display a message 1230 requesting input of a password on the display 120. Thus, the user may input the password by using the remote control 300.

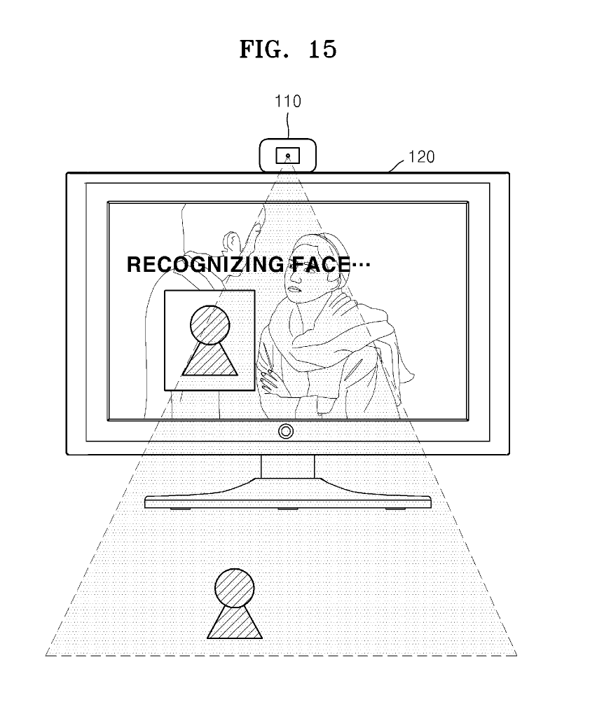

As shown in FIG. 15, if receiving the input for selecting the first personal screen, the user recognition unit 110 may perform face recognition. In this case, the recognized face may be displayed on the display 120.

Alternatively, the image display apparatuses 100 and 200 may receive a user's voice input.

The image display apparatuses 100 and 200 determine whether input user authentication information is a match to authentication information corresponding to the selected personal screen in operation S1050, and if they are a match, the image display apparatuses 100 and 200 determine the selected personal screen in operation S1060.

For example, the image display apparatuses 100 and 200 may display the first personal screen as shown in FIG. 9, if the input predetermined pattern is a match to a password pattern corresponding to the first personal screen.

The image display apparatuses 100 and 200 may display the first personal screen, if the input password matches a password corresponding to the first personal screen.

The image display apparatuses 100 and 200 may also display the first personal screen, if the recognized face is a match with a user's face corresponding to the first personal screen.

The image display apparatuses 100 and 200 may display the first personal screen, if voice print information of an input voice is a match with voice print information corresponding to the first personal screen.

Operation S1060 of FIG. 12 displays a selected personal screen similar to operation S340 of FIG. 4 and thus a detailed description of operation S1060 of FIG. 12 will not be repeated here.

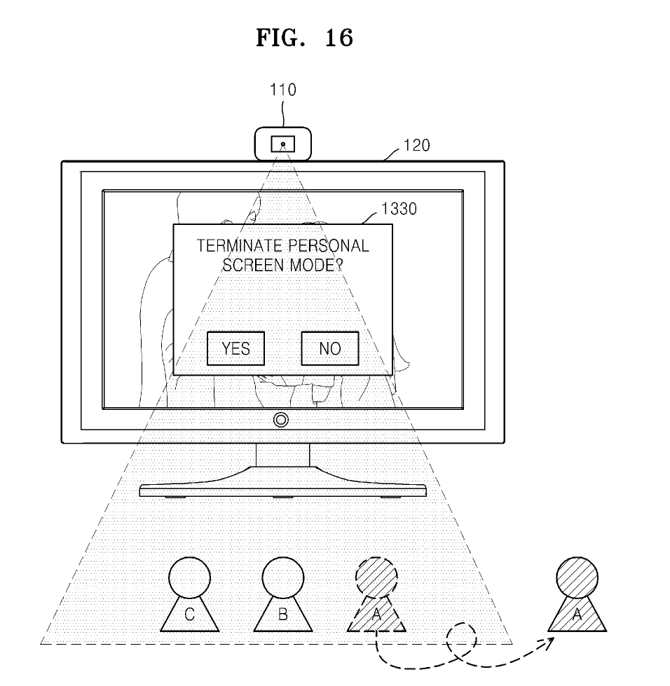

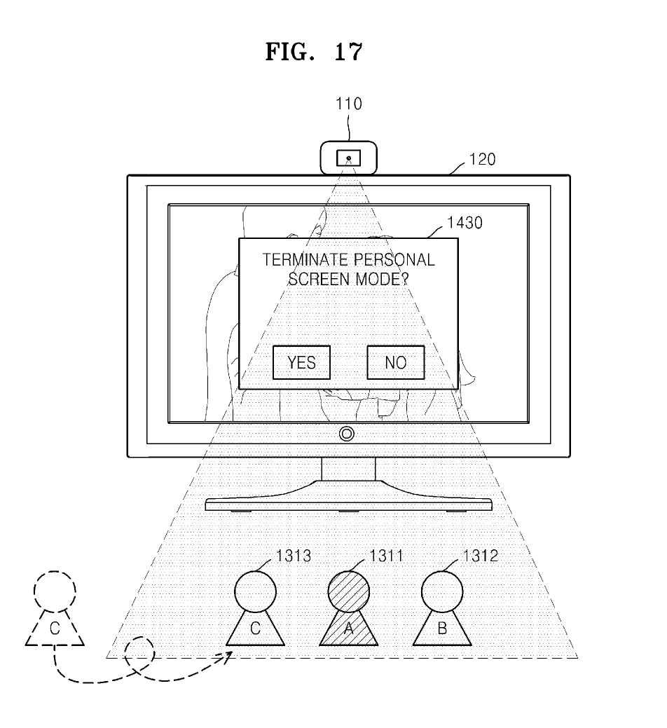

FIGS. 16 and 17 are diagrams for describing termination of the personal screen mode.

The image display apparatuses 100 and 200 may terminate the personal screen mode, if a user corresponding to the displayed personal screen is not recognized when the personal screen is displayed.

For example, as shown in FIG. 16, when the first personal screen corresponding to a first user A is displayed, if the first user A is out of a region that may be recognized by the image display apparatuses 100 and 200, a message 1330 asking whether to terminate the personal screen mode may be displayed. If the user selects ‘YES’, the image display apparatus may terminate the personal screen mode.

As shown in FIG. 17, the image display apparatuses 100 and 200 may terminate the personal screen mode, if a new user who is different from the recognized plurality of users is recognized in operation S410 or S1010 when the personal screen is displayed on the display 120.

For example, when the image display apparatuses 100 and 200 recognize the first user A and the second user B in operation S410 or S1010 and the first personal screen corresponding to the first user A is displayed, if the user recognition unit 110 recognizes a new user C who is different from the first user A and the second user B, then the image display apparatuses 100 and 200 may display a message 1430 asking whether to terminate the personal screen mode. If the user selects ‘YES’, the image display apparatuses 100 and 200 may terminate the personal screen mode.

The image display apparatus and the method of operating the same according to one or more exemplary embodiments are not limited to the constructions and methods of the exemplary embodiments described above, but all or some of the exemplary embodiments may be selectively combined and configured so that the exemplary embodiments may be modified in various ways.

As described above, according to the one or more of the above exemplary embodiments, even for a plurality of users, the personal screen mode is provided for a greater selection of choices.

In addition, based on a recognized user, a selection menu for selecting a personal screen is provided, facilitating a user's selection of the personal screen.

Moreover, the personal screen includes personal content, such that the personal screen may be configured based on personal tastes.

Furthermore, according to an exemplary embodiment, the user is recognized and the personal screen mode is terminated, thus improving user convenience.

The method of operating the image display apparatus or the method of operating the server according to one or more exemplary embodiments may be embodied as a processor-readable code on a recording medium that may be read by a processor included in the image display apparatus or the server. The processor-readable recording medium includes all kinds of recording devices capable of storing data that is readable by a processor. Examples of the processor-readable recording medium include read-only memory (ROM), random access memory (RAM), CD-ROMs, magnetic tapes, floppy disks, optical data storage devices, and carrier waves such as transmission over the Internet. The processor-readable recording medium can also be distributed over a network of coupled computer systems so that the processor-readable code may be stored and executed in a decentralized fashion.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A method of operating an image display apparatus, the method comprising:
recognizing a plurality of users;
displaying a selection menu configured to allow selection of a personal screen corresponding to each of the recognized plurality of users;
receiving an input selecting at least one personal screen from the selection menu; and
displaying the selected at least one personal screen,
wherein the at least one personal screen comprises personal content based on user information.

2. The method of claim 1, further comprising:
receiving an entry command for entering a personal screen mode; and
recognizing the plurality of users in response to receiving the entry command for entering the personal screen mode.

3. The method of claim 1, further comprising:
receiving user authentication information; and
displaying the selected personal screen in response to the received user authentication information matching user identification information corresponding to the selected personal screen.

4. The method of claim 3, wherein the user authentication information comprises at least one of user face information, predetermined pattern information, user voiceprint information, and a password.

5. The method of claim 1, wherein the selection menu comprises an object indicating the at least one personal screen.

6. The method of claim 1, wherein the displaying the selected at least one personal screen comprises:
displaying some predetermined content from among content included in the selected personal screen.

7. The method of claim 1, wherein the displaying the selected at least one personal screen comprises:
displaying a plurality of personal screens on different regions of a display in response to the plurality of personal screens being selected.

8. The method of claim 1, wherein the personal content comprises:
recommended content based on a usage time of the image display apparatus and shared content from another user.

9. The method of claim 1, wherein the user information comprises:
at least one of a gender, an age, a content use history, a search history, and a field of interest of a user.

10. The method of claim 1, further comprising:
terminating the displaying of the personal screen in response to losing recognition of a user corresponding to the displayed at least one personal screen.

11. The method of claim 1, further comprising:
terminating the displaying of the at least one personal screen in response to recognizing a new user who is different from the recognized plurality of users.

12. An image display apparatus comprising:
a user recognition unit configured to recognize a plurality of users;
a display configured to display a selection menu configured for selecting a personal screen corresponding to each of the recognized plurality of users;
a user input receiver configured to receive an input selecting at least one personal screen from the selection menu; and
a controller configured to control the displaying of the selected personal screen,
wherein the at least one personal screen comprises personal content based on user information.

13. The image display apparatus of claim 12, wherein the controller is further configured to recognize the plurality of users in response to receiving an entry command for entering a personal screen mode.

14. The image display apparatus of claim 12,
wherein the user input receiver is further configured to receive user authentication information, and
wherein the controller is further configured to control the displaying of the selected personal screen in response to the received user authentication information matching user identification information corresponding to the selected personal screen.

15. The image display apparatus of claim 14, wherein the user authentication information comprises at least one of user face information, predetermined pattern information, user voiceprint information, and a password.

16. The image display apparatus of claim 12, wherein the controller is further configured to control the displaying of some predetermined content from among content included in the selected at least one personal screen.

17. The image display apparatus of claim 12, wherein the controller is further configured to control the displaying of a plurality of personal screens on different regions of the display in response to the plurality of personal screens being selected.

18. The image display apparatus of claim 12, wherein the personal content comprise recommended content based on a usage time of the image display apparatus and shared content from another user.

19. The image display apparatus of claim 12, wherein the user information comprises at least one of a gender, an age, a content use history, a search history, and a field of interest of the user.

20. A non-transitory computer-readable recording medium having recorded thereon a program for executing a method of operating an image display apparatus on a computer, the method comprising:
recognizing a plurality of users;
displaying a selection menu configured to allow selection of a personal screen corresponding to each of the recognized plurality of users;
receiving an input selecting at least one personal screen from the selection menu; and
displaying the selected at least one personal screen,
wherein the at least one personal screen comprises personal content based on user information.
